(19) United States
(12) Patent Application Publication
(10) Pub. No.: US 2006/0288162 A1
(43) Pub. Date: Dec. 21, 2006

(54) Technology for managing storage units

(75) Inventor: Satoshi Kubota, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/234,143

(22) Filed: Sep. 26, 2005

(30) Foreign Application Priority Data
Jun. 21, 2005 (JP) 2005-181115

(51) Int. Cl. G06F 12/16; G06F 11/00

(52) U.S. Cl. 711/114; 714/2

(57) ABSTRACT

An apparatus manages a plurality of storage units forming a RAID. When a storage unit becomes defective, the apparatus determines whether the defective storage unit can be isolated from other storage units based on a configuration of the defective storage unit. If the defective storage unit can not be isolated, then the apparatus copies data from the defective storage unit a non-defective storage unit and then isolates the defective storage unit.

### BACKGROUND OF THE INVENTION

1. Field of the Invention

The present invention relates to a technology for managing storage units in redundant arrays of independent disks (RAID).

2. Description of the Related Art

Disk array apparatuses are widely used to improve the reliability of data storage and to increase the access speed. In such disk array apparatuses, a plurality of disk devices are connected to a loop such as a fiber channel arbitrated loop (FC-AL) to configure a RAID.

Sometimes a defect occurs in one of the disk devices and the defective disk device needs to be recovered. In that case, the loop becomes fully occupied during the recovery processing, and therefore, access to the other disk devices is inhibited.

A countermeasure has been disclosed in Japanese Patent Application Laid-Open No. 2004-94774. Specifically, the defective disk is isolated from the loop so that other disk devices can be used without problem.

However, if the defective disk device is important from the viewpoint of maintaining the RAID configuration, it can not be isolated.

### SUMMARY OF THE INVENTION

It is an object of the present invention to at least solve the problems in the conventional technology.

An apparatus according to one aspect of the present invention manages a plurality of storage units forming a RAID and includes a determining unit that determines whether to isolate a defective storage unit from among the storage units based on a configuration of the defective storage unit; and an isolating unit that isolates the defective storage unit when the determining unit determines to isolate a defective storage unit.

A method according to another aspect of the present invention is for managing a plurality of storage units forming a RAID and includes determining whether to isolate a defective storage unit based on a configuration of the defective storage unit; and isolating the defective storage unit when it is determined at the determining to isolate a defective storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a disk array apparatus according to an embodiment of the present invention;

FIG. 2 is a functional block diagram of a controller module shown in FIG. 1;

FIG. 3 is an example of data structure of an isolation permission table shown in FIG. 2;

FIG. 4 is a functional block diagram of a disk storage unit shown in FIG. 1; and

FIG. 5 is a flowchart of a process procedure performed by a switch controller shown in FIG. 4.

### DETAILED DESCRIPTION OF THE PREFERRED EMBODIMENTS

Exemplary embodiments of the present invention will be described below with reference to accompanying drawings. The present invention is not limited to these embodiments.

The concept of a storage-unit management apparatus according to an embodiment is explained first. A plurality of disk devices is connected to a loop, forming a RAID configuration. When defects intermittently occur in one of the disk devices (hereinafter, “defective disk device”), the storage-unit management apparatus determines whether the defective disk device is important for maintaining the RAID configuration. If the defective disk device is not important, the defective disk device is isolated from the loop. If the defective disk device is important, the defective disk device is inhibited from being isolated from the loop, and the defective disk device is isolated only after copying data stored in the defective disk device to a backup disk device that is in the loop. As a result, the RAID configuration can be maintained while the defective disk device is being recovered.

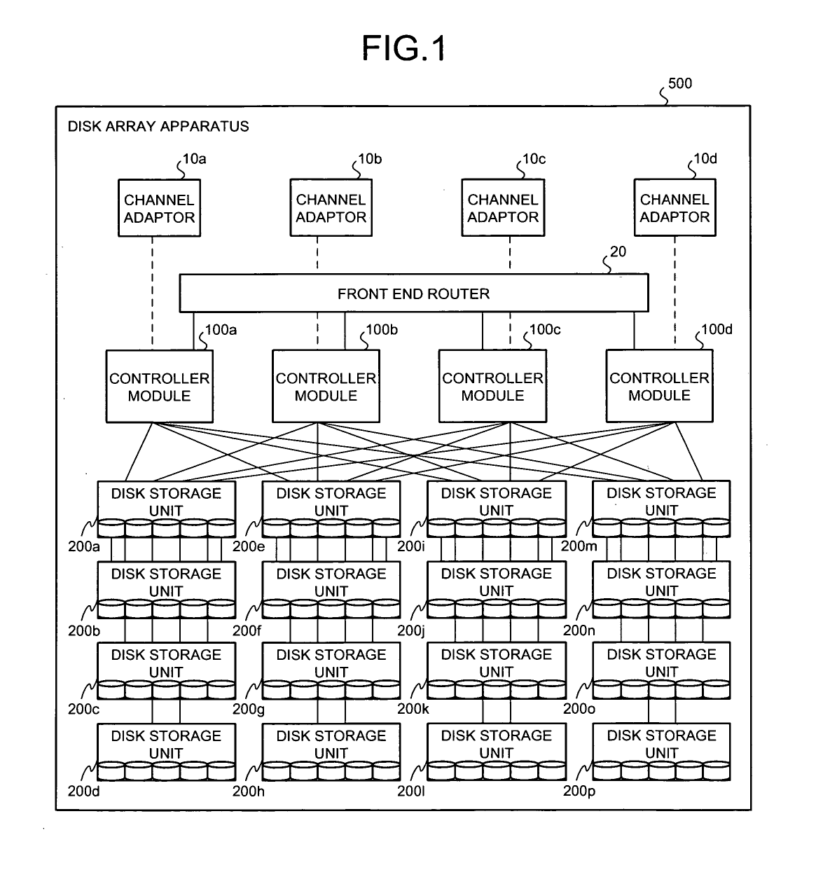

FIG. 1 is a functional block diagram of a disk array apparatus 500 according to the embodiment. The disk array apparatus 500 is an example of the storage-unit management apparatus.

The disk array apparatus 500 includes channel adaptors 10a to 10d, a front end router 20, controller modules 10a to 10d, and disk storage units 200a to 200p.

The channel adaptor 10a connects the disk array apparatus 500 to an external host computer (not shown). The channel adaptor 10a passes the data that it obtains from the host computer to the controller module 100a. Because the channel adaptors 10b to 10d have similar configuration and similar functions to those of the channel adaptor 10a, they will not be described in detail.

The front end router 20 connects the controller modules 100a to 100d to each other. The front end router 20 enables communication of data among the controller modules 100a to 100d. The disk storage units 200a to 200p configure RAID. The controller module 100a holds information relating to RAID configuration, and controls the disk storage units 200a to 200p based on that. Because the controller modules 100b to 100p have similar configurations and similar functions to those of the controller module 100a, they will not be explained in detail.

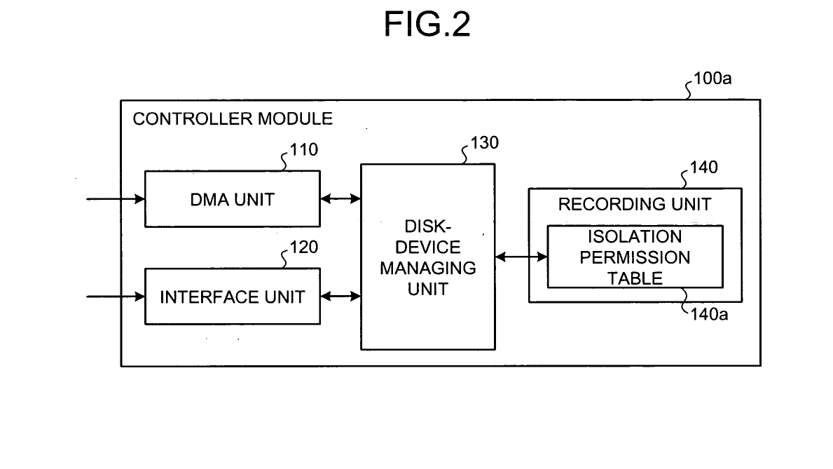

FIG. 2 is a detailed functional block diagram of the controller module 100a. The controller module 100a includes a direct memory access (DMA) unit 110, an interface unit 120, a disk-device managing unit 130, and a recording unit 140.

The DMA unit 110 enables communication of the controller module 100a with the other controller modules 100b to 100d via the front end router 20. The DMA unit 110 uses predetermined communication protocols in communicating with the other controller modules 100b to 100d. The interface unit 120 enables communication of the controller module 100a with the channel adaptor 10a and/or the disk storage units 200a to 200p. The interface unit 120 uses predetermined communication protocols in communicating with the channel adaptor 10a or the disk storage apparatuses 200a to 200p.

The disk-device managing unit 130 manages the disk storage units 200a to 200p. When the disk-device managing unit 130 receives a notification that a defective disk device has been detected, it transmits an isolation permission table 140a to the disk storage unit that is the source of the notification. The isolation permission table 140a is stored in the recording unit 140.

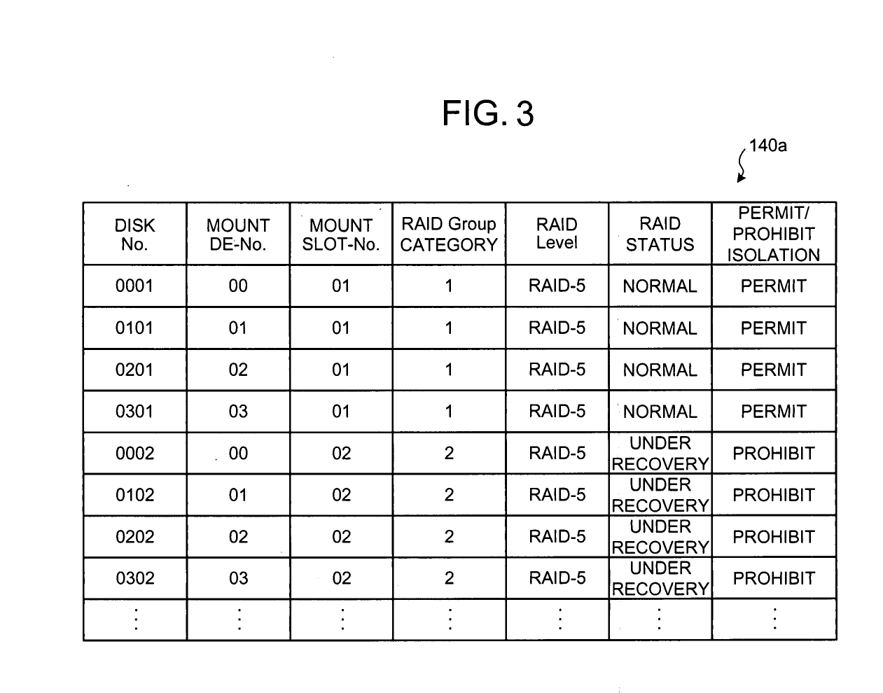

The isolation permission table 140a records information relating to the RAID configuration of disk devices stored in the disk storage units 200a to 200p. FIG. 3 is an example of a data structure of the isolation permission table 140a.

The isolation permission table 140a includes items such as “Disk No.”, “Mount DE-No.”, “Mount SLOT-No.”, “RAID Group Category”, “RAID Level”, “RAID Status”, and “Permit/Prohibit Isolation”. Any other items may be added to this list if necessary.

“Disk No.” is a number that uniquely identifies the physical position of a disk device mounted on a system, and is expressed by combining the “Mount DE-No.” and the “Mount SLOT-No.” For example, when the “Mount DE-No.” is “00” and the “Mount SLOT-No.” is “01”, the “Disk No.” is “0001”.

“RAID Group Category” is information for identifying disk devices included in the same RAID group. In the example shown in FIG. 3, group 1 includes disk devices identified by Nos. 0001, 0101, 0201, and 0301, and group 2 includes disk devices identified by Nos. 0002, 0102, 0202, and 0302. It is obvious that the arrangement of groups is not limited to what is explained here.

“RAID Level” is the level of the RAID formed by each disk device. The “RAID Level” ranges from RAIDs 0 to 5. In the example shown in FIG. 3, the RAID level of the disk device of disk No. 0001 is RAID-5.

“RAID Status” represents the status of the RAID. In the example shown in FIG. 3, the disk devices belonging to the RAID group 1 are operating normally, while the disk devices belonging to the RAID group 2 are being recovered.

“Permit/Prohibit Isolation” is information indicating whether to permit isolation of a disk device when a defect occurs in that disk device. A disk device for which “Permit/Prohibit Isolation” status is “Prohibit”, it means that that disk device is essential for maintaining the RAID configuration so that it can not be isolated.

When the disk-device managing unit 130 obtains information relating to a disk device from the disk storage units 200a to 200p (information such as the start or end of recovery), the disk-device managing unit 130 updates the contents of the isolation permission table 140a based on the obtained information.

In the example shown in FIG. 3, all the disk device belonging to group 2 are being recovered, and their “Permit/Prohibit Isolation” status is “Prohibit”. This means that all the disk devices belonging to group 2 are essential for maintaining the RAID level 5 so that they can not be isolated.

Although not shown in FIG. 3, when there is a group forming a RAID level 3, a disk device holding parity information for data stored in each disk device is essential for maintaining the RAID level 3. In this case, isolation of this disk device is “Prohibit”.

Referring back to FIG. 1, the disk storage unit 200a includes a plurality of disk device for storing data. The disk storage unit 200a controls communication and switching operations among the disk devices, and controls the environment surrounding the disk devices. Because the disk storage units 200b to 200p have similar configurations and similar functions to those of the disk storage unit 200a, they will not be explained in detail.

When a disk device of the disk storage unit 200a becomes defective, the disk storage unit 200a notifies the controller module 100a. In response, the controller module 100a sends the isolation permission table 140a to the disk storage unit 200a. Based on the isolation permission table 140a, the disk storage unit 200a determines whether the defective disk device can be isolated. The defective disk device is isolated only if it can be isolated. In other words, if “Permit/Prohibit Isolation” status of the defective disk device is “Prohibit” it can not be isolated, and if it is “Permit” it can be isolated.

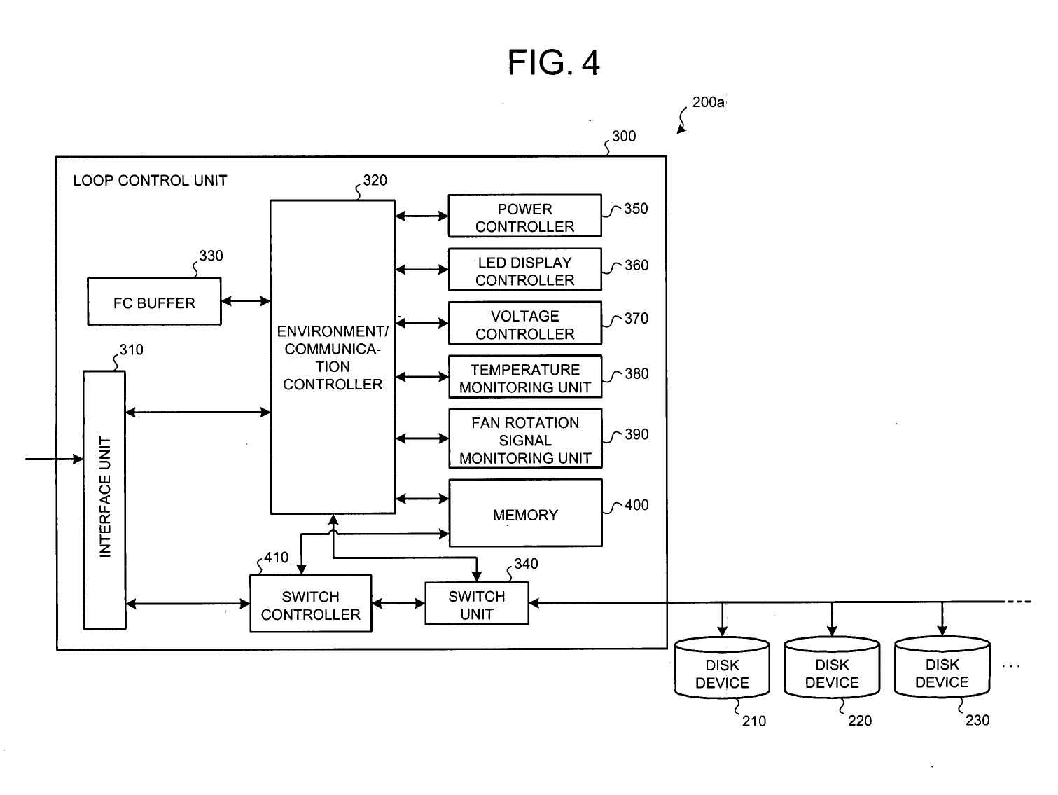

FIG. 4 is a functional block diagram of the disk storage unit 200a. The disk storage unit 200a includes a loop control unit 300 and disk devices 210 to 230. The disk devices 210 to 230 are connected to a loop such as an FC-AL. Although three disk devices 210 to 230 have been shown in FIG. 4, the number of the disk devices is not limited because it is out of the gist of the present invention.

The loop control unit 300 includes an interface unit 310, an environment/communication controller 320, an FC buffer 330, a switch unit 340, a power controller 350, a light emitting diode (LED) display controller 360, a voltage controller 370, a temperature monitoring unit 380, a fan-rotation-signal monitoring unit 390, a memory 400, and a switch controller 410.

The interface unit 310 uses predetermined protocols in communicating with the controller modules 100a to 100d. The environment/communication controller 320 controls communication with the disk devices 210 to 230, and manages various units (not shown) included in the disk storage unit 200a. A power unit, a fan, an LED, and the like, are examples of the various unit included in the disk storage unit 200a.

When a defective disk device is being recovered, the environment/communication controller 320 notifies the controller module 100a of information relating to the defective disk device. Once the recovery is complete, the environment/communication controller 320 notifies the controller module 100a of this fact.

The FC buffer 330 temporarily stores data exchanged between the controller modules 100a to 100d and the disk devices 210 to 230.

The switch unit 340 isolates one of the disk devices connected to the loop, according to instructions from the switch controller 410. As a result, a defective disk device can be isolated from other disk devices in the loop.

The power controller 350 controls the power unit according to instructions from the environment/communication controller 320. Upon receiving an instruction from the environment/communication controller 320 of presence of a defective disk device, the LED display controller 360 flashes an LED (not shown) so that an administrator can know that there is a defective disk device.

The voltage controller 370 monitors and controls a voltage of the disk storage unit 200a. The temperature monitoring unit 380 monitors a temperature inside the disk storage unit 200a, and notifies the environment/communication controller 320 of information relating to the temperature. The fan-rotation-signal monitoring unit 390 monitors the number of rotations of a fan inside a casing (not shown). The memory 400 stores information for controlling hardware (for example, disk devices, the power unit, the fan, and the LED) relating to the disk storage unit 200a.

The switch controller 410 controls the switch unit 340. Specifically, when there is a defective disk device, the switch controller 410 notifies the controller module 100a of this defect and obtains the isolation permission table 140a. Based on the isolation permission table 140a, the switch controller 410 determines whether the defective disk device can be isolated. The defective disk device is isolated only if it can be isolated. In other words, if “Permit/Prohibit Isolation” status of the defective disk device is “Prohibit” it can not be isolated, and if it is “Permit” it can be isolated. If the defective disk device can be isolated, the switch controller 410 isolates the defective disk device from the loop.

On the other hand, if the switch controller 410 can not be isolated, the switch controller 410 copies data recorded on the defective disk device to a backup disk device that is operating normally. Because the backup disk device can now be used instead of the defective disk device, the defective disk device is isolated.

For example, when a defect occurs in the disk device 210 that cannot be isolated, and the disk device 230 is the backup disk device, the switch controller 410 copies data recorded in the disk device 210 to the disk device 230. Thereafter, data to be written into the disk device 210 is written into the disk device 230.

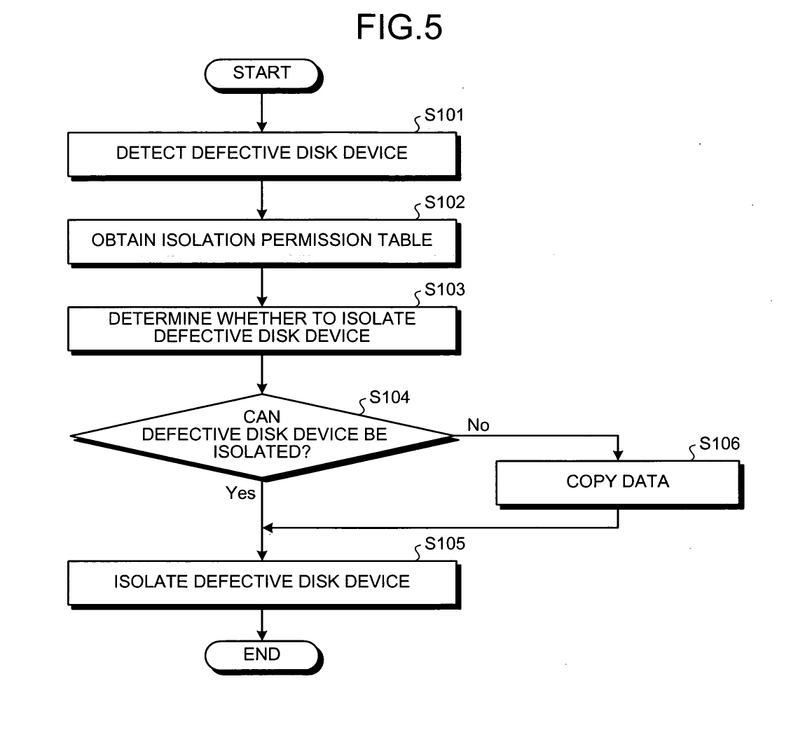

FIG. 5 is a flowchart of a process procedure performed by the switch controller 410. When the switch controller 410 detects a defective disk device on the loop (step S101), the switch controller 410 obtains the isolation permission table 140a from the controller module 100a (step S102).

The switch controller 410 determines, based on the isolation permission table 140a, whether to isolate the defective disk device (step S103). If the defective disk device can be isolated (step S104, Yes), the switch controller 410 isolates the defective disk device (step S105).

On the other hand, when the defective disk device cannot be isolated (step S104, No), the switch controller 410 copies data stored in the defective disk device to a backup disk device that is operating normally (step S106). Because the backup disk device can now be used instead of the defective disk device, the switch controller 410 isolates the defective disk device (step S105).

Thus, when a defect is detected in a disk device connected to the loop, the switch controller 410 obtains the isolation permission table 140a from the controller module 100a and determines, based on the isolation permission table 140a, whether to isolate the disk device. Accordingly, a defective disk device can be recovered while maintaining the RAID configuration.

As described above, in the disk array apparatus 500 according to this embodiment, when one of the disk storage units 200a to 200p (for example, the disk storage unit 200a) detects a defect in a disk device stored therein, disk storage unit 200a requests the isolation permission table 140a from the controller module 100a. The disk storage unit 200a then determines, based on the isolation permission table 140a, whether the defective disk device can be isolated. Since the defective disk device is isolated only when permitted, defects in the disk device can be recovered while maintaining the RAID configuration.

Similar results can be obtained by storing an isolation permission table in each of the disk storage units 200a to 200p. In this case, the disk storage units 200a to 200p mutually exchange information to update the isolation permission tables.

According to the above embodiment, a RAID configuration to which a defective storage unit belongs can be maintained while recovering the defective storage unit.

Moreover, a defect in a storage unit can be efficiently recovered while maintaining a RAID configuration to which the defective storage unit belongs.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for managing a plurality of storage units forming a RAID, comprising:
a determining unit that determines whether to isolate a defective storage unit from among the storage units based on a configuration of the defective storage unit; and
an isolating unit that isolates the defective storage unit when the determining unit determines to isolate a defective storage unit.

2. The apparatus according to claim 1, wherein the determining unit determines to isolate the defective storage unit when a configuration of the defective storage unit is such that the RAID can be maintained even when the defective storage unit is isolated.

3. The apparatus according to claim 1, wherein the determining unit determines not to isolate the defective storage unit when a configuration of the defective storage unit is such that the RAID can not be maintained when the defective storage unit is isolated.

4. The apparatus according to claim 1, further comprising a copying unit configured to copy data stored in the defective storage unit into another storage unit that is not defective from among the storage units when the determining unit determines not to isolate the defective storage unit, wherein
the determining unit determines to isolate the defective storage unit once the copying unit has copied the data from the defective storage unit into the another storage unit.

5. The apparatus according to claim 1, further comprising a storing unit that stores therein RAID configuration information of each of the storage units, wherein
the determining unit determines whether to isolate the defective storage unit based on the RAID configuration information corresponding to the defective storage unit.

6. The apparatus according to claim 1, wherein defects intermittently occur in the defective storage unit.

7. An method of managing a plurality of storage units forming a RAID, comprising:
determining whether to isolate a defective storage unit based on a configuration of the defective storage unit; and
isolating the defective storage unit when it is determined at the determining to isolate a defective storage unit.

8. The method according to claim 7, wherein the determining includes determining to isolate the defective storage unit when a configuration of the defective storage unit is such that the RAID can be maintained even when the defective storage unit is isolated.

9. The method according to claim 7, wherein the determining includes determining not to isolate the defective storage unit when a configuration of the defective storage unit is such that the RAID can not be maintained when the defective storage unit is isolated.

10. The method according to claim 7, further comprising:
copying data stored in the defective storage unit into another storage unit that is not defective from among the storage units when it is determined at the determining not to isolate the defective storage unit, wherein
the determining includes determining to isolate the defective storage unit once the data has been copied from the defective storage unit into the another storage unit at the copying.

11. The method according to claim 7, further comprising storing RAID configuration information of each of the storage units, wherein
the determining includes determining whether to isolate the defective storage unit based on the RAID configuration information corresponding to the defective storage unit.

12. The method according to claim 7, wherein defects intermittently occur in the defective storage unit.
